(19) United States
(12) Patent Application Publication
(10) Pub. No.: US 2025/0231711 A1
(43) Pub. Date: Jul. 17, 2025

(54) MEMORY SYSTEM USING ZONED NAME SPACE AND DATA PROCESSING SYSTEM INCLUDING THE SAME

(71) Applicant: SK hynix Inc., Icheon-si (KR)

(72) Inventor: Kyu Ho CHOI, Icheon-si (KR)

(21) Appl. No.: 18/792,353

(22) Filed: Aug. 1, 2024

(30) Foreign Application Priority Data
Jan. 17, 2024 (KR) 10-2024-0007362

(51) Int. Cl. G06F 3/06

(52) U.S. Cl. CPC G06F 3/0659; G06F 3/0604; G06F 3/0679

(57) ABSTRACT

A memory system employing a zoned name space may include a memory device including a plurality of physical areas corresponding to each of a plurality of zones; and a memory controller configured to control the memory device to perform a write operation on the physical areas, wherein, when a write request is received from a host device, the memory controller, determines a size of a physical free area, in which no data is stored, that is included in a target zone of the write request, compares the size of the physical free area and a size of user data requested to be written, and determines whether to transmit free area information on an additional free area required in the target zone for a write operation on the user data, to the host device, according to a result of the comparison.

### CROSS-REFERENCE TO RELATED APPLICATION

This patent application claims the benefit of priority under 35 U.S.C. § 119 (e) to Korean Patent Application No. 10-2024-0007362, filed on Jan. 17, 2024 in the Korean Intellectual Property Office, the entire disclosure of which is incorporated herein by reference.

### TECHNICAL FIELD

Exemplary embodiments relate to a memory system and a data processing system including the same, and more particularly, to a memory system using a zoned name space and a data processing system including the same.

### BACKGROUND

The computer environment paradigm is transitioning to ubiquitous computing, enabling computing to appear anytime and anywhere. The recent increase in the use of ubiquitous computing is leading to an increase in the use of portable electronic devices such as mobile phones, digital cameras, and laptop computers. In general, such portable electronic devices use a memory system or a memory system that includes a memory device, such as a semiconductor memory device, as its data storage medium. The memory system is used as a main memory device or an auxiliary memory device of portable electronic devices.

Such a semiconductor-based memory system provides advantages over traditional hard disk drives since semiconductor memory devices have no mechanical moving parts, and thus offers excellent stability and durability, high data rate, and low power consumption. Examples of semiconductor-based memory systems include a universal serial bus (USB) memory device, memory cards, and a solid state drive (SSD).

### SUMMARY

The embodiments of the disclosed technology relate to a memory system that exhibits improved operational stability of a zoned name space.

An embodiment of the present disclosure may provide a memory device, a memory system, a memory controller included in the memory system, a data processing system including the memory system or the memory device, or a communication system for transmitting data.

Various embodiments of the present disclosure are directed to providing a memory system with improved zone utilization of a zoned name space and a data processing system including the same.

Various embodiments of the present disclosure are directed to providing a memory system capable of synchronizing write pointers respectively managed by a host device and a memory system and a data processing system including the same.

A memory system and a data processing system including the same according to embodiments of the present disclosure may improve zone utilization of a zoned name space.

A memory system and a data processing system including the same according to embodiments of the present disclosure may synchronize write pointers respectively managed by a host device and a memory system so that the write pointers are identical to each other.

In an embodiment of the present disclosure, a memory system employing a zoned name space, the memory system comprising: a memory device including a plurality of physical areas corresponding to each of a plurality of zones; and a memory controller configured to control the memory device to perform a write operation on the physical areas, wherein, when a write request is received from a host device, the memory controller, determines a size of a physical free area, in which no data is stored, that is included in a target zone of the write request, compares the size of the physical free area and a size of user data requested to be written, and determines whether to transmit free area information on an additional free area required in the target zone for a write operation on the user data, to the host device, according to a result of the comparison.

In another embodiment of the present disclosure, data processing system comprising: a host device, including a plurality of logical areas corresponding to each of a plurality of zones, configured to allocate a user data to a logical free area of a target zone and to generate a write request for the allocated user data; and a memory system configured to transmit a response, to the host device, indicating whether a write operation corresponding to the write request has failed, wherein the host device determines whether to invalidate at least some of valid logical areas included in the target zone, according to a comparison result of a size of the logical free area and a size of the user data, when the host device allocates the user data.

### BRIEF DESCRIPTION OF THE DRAWINGS

FIGS. 1A to 1C are diagrams illustrating a storage method of a memory system.

FIG. 2 is a diagram illustrating a storage method for a data processing system that utilizes a zoned name space.

FIG. 3 is a diagram for explaining zone states in accordance with embodiments of the present disclosure.

FIG. 4 is a block diagram for explaining a data processing system in accordance with an embodiment of the present disclosure.

FIGS. 5A and 5B are diagrams illustrating a write pointer when data is written to a zoned name space (ZNS).

FIG. 6 is a flowchart illustrating a method for updating a logical write pointer and a physical write pointer in accordance with an embodiment of the present disclosure.

FIG. 7 is a diagram for illustrating a ZNS operation that uses a logical write pointer and a physical write pointer in accordance with an embodiment of the present disclosure.

FIG. 8 is a diagram illustrating a process of updating a logical write pointer and a physical write pointer when internal data is written according to a method illustrated in FIG. 6.

FIG. 9 is a diagram illustrating a process of updating a logical write pointer and a physical write pointer when the user data is written in accordance with the method illustrated in FIG. 6.

FIG. 10 is a flowchart illustrating an operation of a memory controller in accordance with an embodiment of the present disclosure.

FIG. 11 is a flowchart illustrating an operation in which a host device generates a write request in accordance with an embodiment of the present disclosure.

FIG. 12 is a flowchart illustrating an operation in which a memory system in accordance with another embodiment of the present disclosure determines whether to perform a write operation.

FIG. 13 is a flowchart illustrating a method in which a host device performs a subsequent operation in response to a write request received from a memory system in accordance with an embodiment of the present disclosure.

FIGS. 14A to 14E are diagrams illustrating a process of performing a write operation described FIGS. 11 to 13.

### DETAILED DESCRIPTION

Various embodiments of the present disclosure are described below with reference to the accompanying drawings. Elements and features of this disclosure, however, may be configured or arranged differently to form other embodiments, which may be variations of any of the disclosed embodiments.

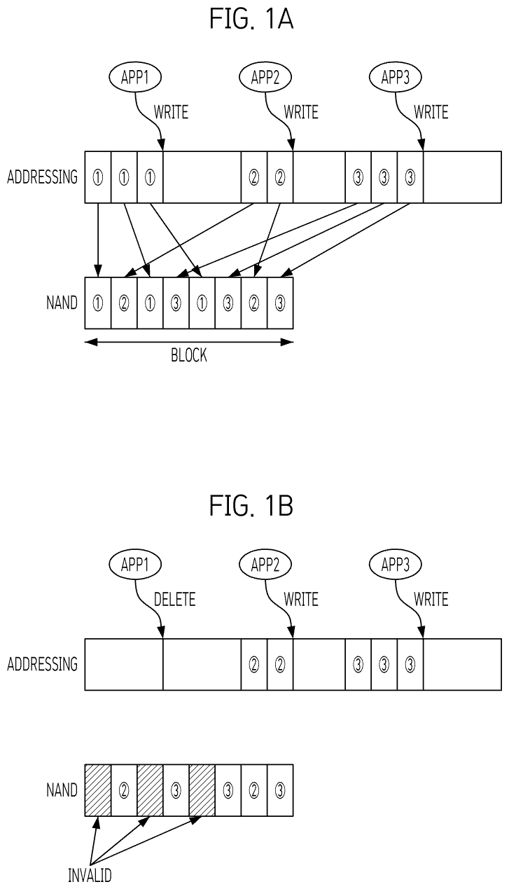

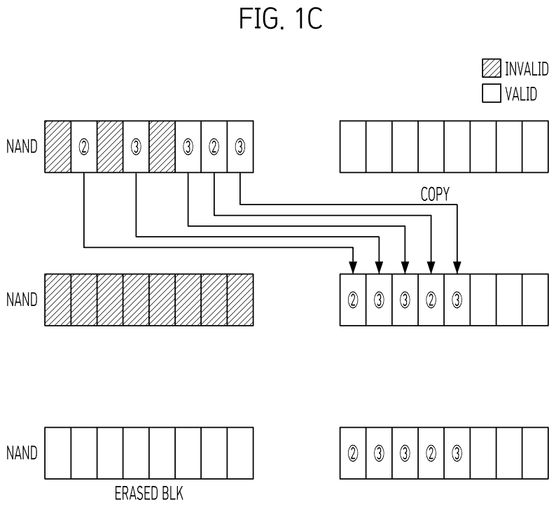

FIGS. 1A to 1C are diagrams illustrating a data storage method for a memory system.

Technologies such as artificial intelligence, big data, and cloud computing are operated through a data center. The data center includes a memory system implemented as a flash memory, and a plurality of applications may be used with the memory system. The plurality of applications may run on a host device such as a computer or a mobile phone. Each of the plurality of applications stores data at logical block addresses (LBA), and the memory system stores the data, stored at the logical block addresses, in one physical block. After pieces of data provided from different applications have been stored in one physical block, the memory system may map the logical block addresses to a physical address (PBA) of the physical block.

FIG. 1A illustrates three applications used with a memory system by way of example.

A plurality of logical block addresses are divided into areas corresponding to a plurality of applications, respectively, and the plurality of applications store data at logical block addresses included in areas corresponding thereto. As illustrated in FIG. 1A, a first application APP1 stores data at three logical block addresses, a second application APP2 stores data at two logical block addresses, and a third application APP3 stores data at three logical block addresses. The memory system programs pieces of data, stored in areas respectively corresponding to the first to third applications APP1 to APP3, to one physical block. Therefore, one physical block BLOCK includes all of the pieces of data for the first to third applications APP1 to APP3.

FIG. 1B illustrates an erase operation performed in a memory system when a first application erases data.

The memory system performs a read operation and a write operation on a page basis, but performs an erase operation on a physical block basis. When the first application APP1 issues an erase command for the programmed data, and the pieces of data for a plurality of applications are stored in one physical block BLOCK, the memory system may invalidate data corresponding to the first application APP1. As illustrated in FIG. 1B, among pieces of data included in the physical block BLOCK, data corresponding to the first application APP1 are invalidated, and pieces of data corresponding to the second and third applications APP2 and APP3 remain valid. When the size of invalid data included in the physical block increases, the available capacity of the memory system is decreases, and thus the memory system may switch an area in which invalid data is stored to an area available for data storage by performing a garbage collection (GC).

FIG. 1C is a diagram illustrating a garbage collection performed on a physical block BLK.

The memory system copies valid data stored in the physical block BLK to a free physical block. Referring to FIG. 1C, the memory system copies the pieces of data for the second and third applications APP2 and APP3, which are pieces of valid data, to the free physical block. After the pieces of valid data have been copied to the free physical block, the memory system invalidates all valid data stored in the physical block, and then performs an erase operation on the physical block. Thus, the memory system performs garbage collection by copying the valid data present in a physical block including invalid data to the free physical block, and thereafter performing an erase operation on the physical block.

When an issued erase command pertains to only one application, the size of invalid data included in the physical block increases and garbage collection may be necessary. When a garbage collection for removing invalid data is performed, a read operation and a write operation that are currently being performed are temporarily suspended, and thus the performance of the memory system may deteriorates. A data processing system that utilizes Zoned Name Spaces (ZNS) may address problems that arise from conflicts between operation of a plurality of applications and the deterioration of performance caused by garbage collection.

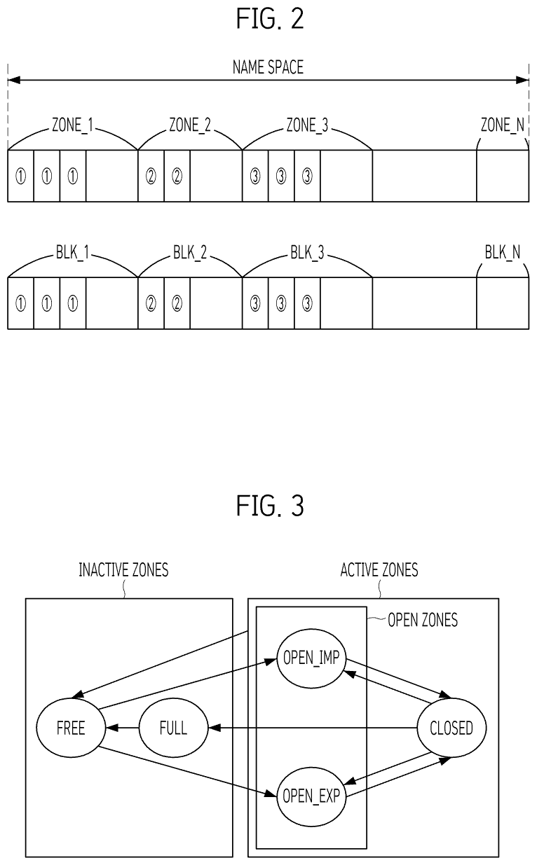

FIG. 2 is a diagram illustrating a data storage method for a data processing system that utilizes a zoned name space.

In some implementations, a memory system may include a data storage space that is divided into a plurality of data storage zones. For example, the memory system may include newer solid state drive (SSD) types such as zoned name space (ZNS) drive, which enables the host device of the SSD to allocate a smaller SSD segment (e.g., a zone or aggregation of multiple zones) for a specific requestor application to allow a finer grain differentiation with the others. A zoned name space (ZNS) denotes a technology of utilizing a namespace by dividing the namespace into smaller segments or units such as zones. The namespace denotes the size of a nonvolatile memory that can be formatted to a logical block. In the data processing system that utilizes a zoned name space, a plurality of applications can sequentially store pieces of data at logical block addresses of their own designated zones. Not only a plurality of logical block addresses but also physical areas of a memory system are divided into zones. Since one zone stores data for the same application, the attributes of the pieces of data stored in one zone are similar to each other. Also, the logical block addresses included in one zone are consecutive, and physical blocks corresponding to respective zones are always sequentially programmed in the memory system to which a zoned name space is applied.

Referring to FIG. 2, one namespace may be composed of a plurality of zones ZONE_1 to ZONE_N. Respective sizes of the plurality of zones ZONE_1 to ZONE_N are equal to each other. One application may correspond to one zone, or may correspond to a plurality of zones in some cases. One zone includes a plurality of consecutive logical block addresses. An internal area of the memory device is also divided into units such as zones, and zones in a logical area respectively correspond to zones in a physical area. The sizes of respective zones in the physical area are equal to each other, and the size of each of the zones may be an integer multiple of an erase unit. For example, one zone may correspond to a physical block that is an erase unit, and first to N-th physical blocks BLK_1 to BLK_N illustrated in FIG. 2 may correspond to the first to N-th zones ZONE_1 to ZONE_N, respectively.

In an example, first to third applications APP1 to APP3 correspond to the first to third zones ZONE_1 to ZONE_3, so the first application APP1 stores data at logical block addresses included in the first zone ZONE_1. The logical block addresses included in the first zone ZONE_1 are consecutive, and a host device provides identification information for the corresponding zone and program data, together with a write command, to the memory system. The memory system sequentially programs the pieces of data, stored at the logical block addresses included in the first zone ZONE_1, to the first physical block BLK_1 corresponding to the first zone ZONE_1 based on the identification information for the zone.

Similarly, pieces of data for the second zone ZONE_2 and the third zone ZONE_3 may be stored in the second physical block BLK_2 and the third physical block BLK_3, respectively. When a memory system utilizes a zoned name space, pieces of data provided from different applications are stored in different areas, among internal areas of the memory device, which are divided into zones. Therefore, an erase operation limited to a single application does not influence data for other applications.

When the memory system uses a zoned name space, pieces of data are sequentially stored in physical blocks corresponding to zones, after which the pieces of data are deleted on a zone basis, and thus garbage collection is not needed. Therefore, the memory system to which the zoned name space is applied has a very low write amplification factor (WAF) value. The WAF denotes how many additional programming operations, other than regular write operations, should be performed in the memory system (e.g., garbage collection), and is obtained by dividing the size (amount) of data actually programmed in the memory device by the size of data programmed in response to a host device request. When a garbage collection is not performed, the value of WAF may be close to a value of “1.”

The memory system can only perform a limited number of write operations. Since a write operation attributable to a garbage collection does not occur in the memory system that utilizes a zoned name space, the lifespan of the memory system increases. Further, the size of an over-provision area decreases. The over-provision area is a spare area in the memory device that is not recognized by the host device, and includes an area for a background operation of the memory system, such as garbage collection. In an example implementation, a memory system stores a table that includes mapping information between logical block addresses and physical addresses, in a volatile memory provided in a memory controller. In contrast, in the memory system that utilizes a zoned name space, the memory device is used after being divided into zones of the same size, and write operations are sequentially performed in each of the zones, and thus a separate mapping table is not required. Therefore, the memory system that utilizes a zoned name space uses volatile memory more efficiently.

The size of data provided by the host device to the memory system at any given time is different from that of a program unit of the memory system. For example, in a triple-level cell (TLC) memory device, the size of a program unit may be a value obtained by summing the sizes of a Least Significant Bit (LSB) page, a Central Significant Bit (CSB) page, and a Most Significant Bit (MSB) page, and the size may be greater than the size of data that is provided by the host device to the memory system at that time. Therefore, the memory system temporarily stores program data in a write buffer provided in a memory controller disposed between the host device and the memory device, and programs the data to a physical block when the size of the stored data satisfies a size of the program unit. For example, the program unit may include a page of the physical block. The memory system may allocate the area of the write buffer for each zone, and the size of the area allocated to one zone may be that of the program unit. An open zone denotes a zone to which the area of the write buffer is allocated, and the memory system performs a write operation only on the physical block corresponding to the open zone. In one example, the open zone may include erased memory cells that are available for writes by the host devices. In another example, the open zone may include partially programmed memory cells that are available for further writes by the host devices.

Since the write buffer is implemented as a volatile memory, there is a concern that, when the power of the memory system fails, data stored in the write buffer will be lost. Therefore, the memory system is provided with an emergency power supply, and backs up the data, stored in the write buffer, to a nonvolatile memory using power supplied from the emergency power supply when a power failure occurs. Since the emergency power supply is capable of supplying power for a limited period of time, the size of data that can be backed up by the memory system from the write buffer to the nonvolatile memory within the limited time is also limited. Therefore, the size of the write buffer is defined as the size of data that can be backed up during the time during which power is supplied from the emergency power supply. Since the size of the write buffer is limited, the number of zones to which the areas of the write buffer are allocated is also limited. Therefore, the number of open zones that can be simultaneously present or available is limited, and the number of applications that can simultaneously run is limited when the number of open zones that can be simultaneously present or available is limited. If a data center in communication with a server can only perform a small number of applications simultaneously, its performance would be negatively affected.

FIG. 3 is a diagram showing zone states.

The zones may be classified into active zones (ACTIVE ZONES) and inactive zones (INACTIVE ZONES) depending on states that respective zones can have. In FIG. 3, the active zones include open zones (OPEN ZONES) and a closed zone (CLOSED), and the inactive zones include a free zone (FREE) and a full zone (FULL). The number of open zones is limited by the capacity of a write buffer, as described above. In addition, the number of closed zones is limited, and thus the number of active zones is also limited.

The above-described open zones may be classified into an explicitly opened zone and an implicitly opened zone. When the host device explicitly provides a command for instructing a certain zone to switch to an open zone to the memory system, the open zone switched in response to the command may be an explicitly opened zone OPENED_EXP. When the host device provides only a write command and identification information corresponding to the zone to the memory system without explicitly providing a command for instructing to switch to an open zone, the memory system autonomously switches the zone to an open zone and performs a write operation. The open zone autonomously switched by the memory system is an implicitly opened zone OPENED_IMP. When a write command for a zone other than an open zone is issued in the state in which all areas of the write buffer are allocated to open zones, the memory system switches any one of the open zones to a closed zone (CLOSED). The closed zone may be switched from the open zone. When a write command is issued for the closed zone, which is switched for the above-described reason, the corresponding closed zone (CLOSED) may switch back to the open zone.

When pieces of data in all physical blocks in a physical block corresponding to an open zone are completely programmed, the memory system switches the open zone to a closed zone, and then switches the closed zone to a full zone. Such a full zone (FULL) denotes a zone in which no free area is present in the corresponding physical block. When an application provides an erase command for the full zone or the active zones to the memory system, the memory system performs an erase operation on the physical block corresponding to the zone for the erase command, and thereafter switches the zone to a free zone. The free zone (FREE) denotes a zone in which the corresponding physical block is a free physical block.

As described above, the number of zones included in the active zones is limited. In a situation in which all areas in the write buffer are allocated to open zones and the number of closed zones cannot be increased any further, if a new application runs and an open zone is generated, then the memory system cannot further allocate new open zones. Therefore, when the number of zones included in the active zones reaches a threshold value, a problem arises in that the number of applications that may simultaneously run cannot be increased any further.

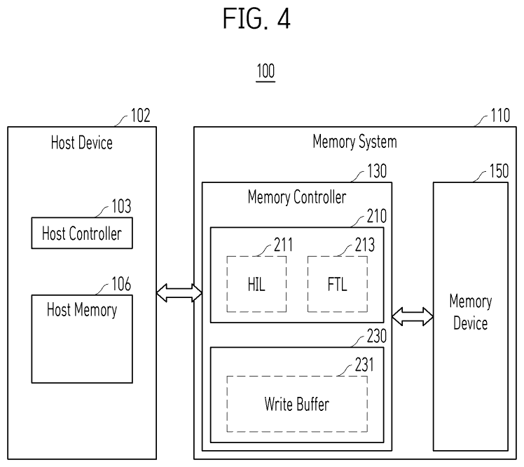

FIG. 4 is a block diagram for explaining a data processing system in accordance with an embodiment of the present disclosure. Referring to FIG. 4, a data processing system 100 includes a host device 102 and a memory system 110.

The host device 102 may be a device such as a mobile phone, a MP3 player, a laptop computer, a desktop computer, a game console, a TV, and an in-vehicle infotainment system. The host device 102 may include a host device memory controller 103. Although not illustrated in FIG. 1, the host device 102 may include a processing unit (for example, a central processing unit) and a driving unit. The processing unit may control the overall operation of the host device 102, and the driving unit may drive the memory system 110 under the control of the processing unit. In an embodiment, a driving unit of the host device 102 may include an application (not illustrated), the host device memory controller Host Controller 103, and a host device memory Host Memory 106.

The memory system 110 may include a memory device 150 and a memory controller 130. The memory system 110 may communicate with the host device 102. The memory device 150 may be a nonvolatile memory device. As an example, the memory device 150 may be a NAND flash memory device. The memory device 150 may operate under the control of the memory controller 130. More specifically, the memory device 150 may operate in response to commands received from the memory controller 130.

The memory controller 130 may include a data processing unit 210 and a memory unit 230. The data processing unit 210 may include a host device interface layer (HIL) 211 and a flash translation layer (FTL) 213. The memory unit 230 may include a write buffer 231.

The HIL 211 of the data processing unit 210 may perform operations related to communication between the memory controller 130 and the host device 102. More specifically, the HIL 211 may receive a write request from Host device 102. When the HIL 211 receives the write request from the host device 102, the HIL 211 may receive the user data U_DAT from the host device 102. The received the user data U_DAT may be stored in the write buffer 231 of the memory unit 230.

The FTL 213 of the data processing unit 210 may control the operation of the memory device 150 in response to requests received from the host device 102. For example, when the HIL 211 receives the write request and the user data U_DAT from the host device 102, the FTL 213 may generate a corresponding write command and program data corresponding to the write request and the user data U_DAT and transmit the generated write command and program data to the memory device 150.

In an embodiment, the HIL 211 and the FTL 213 may be configured as one processing unit. In this case, the data processing unit 210 may be implemented as one processing unit. In another embodiment, the HIL 211 and the FTL 213 may be configured as separate processing units.

The write buffer 231 included in the memory unit 230 may temporarily store the user data U_DAT received from the host device 102. The user data U_DAT temporarily stored in the write buffer 231 may be converted into program data and transmitted to the memory device 150. In this process, program data may be generated through a data randomizing operation and an ECC encoding operation on the user data U_DAT.

In the following description, an area, where the user data U_DAT is allocated and stored, is indicated by a fine hatching pattern. An area, where the internal data IN_DAT is allocated and stored, is indicated by a rough hatching pattern. A free area, where no data is allocated and stored is displayed as a free area.

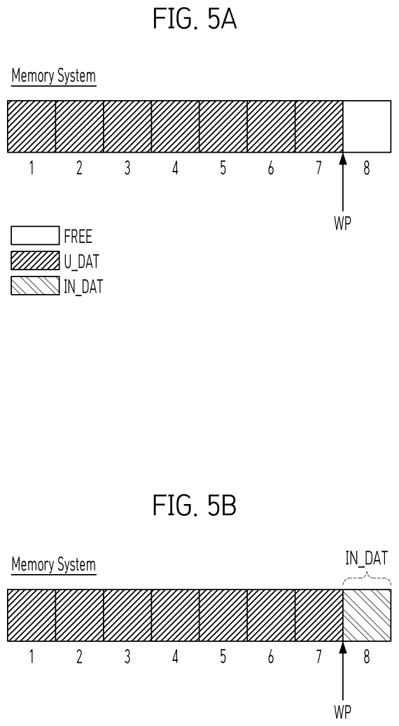

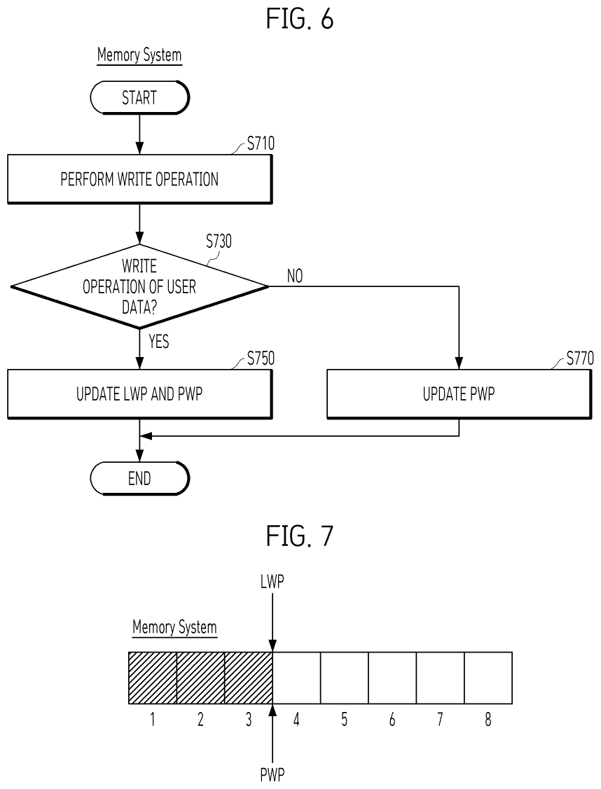

FIGS. 5A and 5B are diagrams illustrating a write pointer when data is written to a zoned name space (ZNS).

Referring to FIG. 5A, a plurality of physical blocks included in one zone of a memory device 150 are exemplarily illustrated. For convenience of description, one zone is illustrated as including eight physical blocks in FIGS. 5A and 5B.

Whenever a write operation is performed in the zone, an area indicated by a write pointer WP is moved by one physical block. When executing the command, the memory controller 130 may write the data within the zone indicated, but in some implementations, the data may be written based on a write pointer position. In one example, each zone may have a write pointer WP, maintained by the memory controller 130 or the memory system, that keeps track of the start position of the next write operation. FIG. 5A shows that pieces of data are written to physical blocks ranging from physical block #1 to physical block #7 in the zone, and are not written to physical block #8.

Referring to FIG. 5B, internal data IN_DAT is written during the writing of data is illustrated. In a memory system 110 that utilizes a zoned name space, a situation in which the internal data IN_DAT is written to some of a plurality of physical blocks included in a zone may happen. For example, the internal data IN_DAT may include valid data that is migrated from a victim block to a destination block by an internal background operation (e.g., garbage collection, wear levelling, etc.) performed by the memory system 110. The internal data IN_DAT may also include metadata related to a write operation of the user data U_DAT. The internal data IN_DAT may be generated by the memory system 110, not the user data U_DAT requested to be written from the host device 102. That is, the internal data IN_DAT may be data irrelevant to the user data U_DAT transferred from the host device 102 to the memory system 110, and internal data IN_DAT may be data autonomously generated by the memory system 110.

FIG. 5B, areas to which the internal data IN_DAT is written are illustrated as rough hatching pattern. That is, the internal data IN_DAT is written to physical block #8 in the zone. During the writing of the internal data IN_DAT, a write pointer WP is not moved because the internal data IN_DAT is not the user data received from the host device 102. Accordingly, even if the write pointer WP still indicates physical block #7, data is actually written to all of physical blocks (ranging from physical block #1 to physical block #8) in the zone. That is, although the zone is full, the write pointer WP indicates physical block #8 as if the physical block #8 was a free physical block.

In accordance with a memory system 110 and a method of operating the memory system 110 based on the disclosed technology, a write pointer WP in a zone may include a logical write pointer LWP and a physical write pointer PWP. The logical write pointer LWP may indicate a logical position of the last user data U_DAT allocated to the zone from a standpoint of the host device 102. Also, the logical write pointer LWP may indicate a physical position of the last user data U_DAT written to the zone from a standpoint of the memory controller 130. The logical write pointer LWP may be managed by the host device 102 and the memory controller 130.

The physical write pointer PWP may indicate a physical position of the last data, including the internal data IN_DAT and the user data U_DAT, written to the zone of the memory device 150 from a standpoint of the memory controller 130. The physical write pointer PWP may be managed by the memory controller 130. That is, the physical write pointer PWP may indicate the location of the last data that is actually written to the memory device 150 by a write operation performed by the memory controller 130.

FIG. 6 is a flowchart illustrating a method of updating a logical write pointer and a physical write pointer by a memory controller in accordance with an embodiment of the present disclosure. FIGS. 7 to 9 illustrate methods for updating the logical write pointer LWP and the physical write pointer PWP based on the method illustrated in FIG. 6.

Referring to FIG. 6, a memory controller 130 performs a write operation on a memory device 150 at step S710. At step S710, the memory controller 130 may generate a write command for the memory device 150. The memory device 150 may perform a write operation in response to the write command received from the memory controller 130.

At step S730, whether the write operation performed on the memory device 150 corresponds to a write request received from the host device 102 is determined. When it is determined that the write operation performed on the memory device 150 corresponds to the write request received from the host device 102 (i.e., “Yes” at step S730), the data stored in the memory device 150 is the user data U_DAT received from the host device 102. Therefore, the memory controller 130 updates both the logical write pointer LWP and the physical write pointer PWP of a zone corresponding to the write operation at step S750.

When it is determined that the write operation performed on the memory device 150 does not correspond to the write request received from the host device 102 (i.e., “No” at step S730), it means that the data stored in the memory device 150 is the internal data IN_DAT, not the user data U_DAT received from the host device 102. Therefore, the memory controller 130 updates the physical write pointer PWP of the zone corresponding to the write operation, performed at step S770. At step S770, the logical write pointer LWP is not updated.

FIG. 7 is a diagram illustrating a ZNS operation that uses a logical write pointer and a physical write pointer in accordance with an embodiment of the present disclosure. Referring to FIG. 7, a write pointer WP in a zone is managed such that it is separated into a logical write pointer LWP and a physical write pointer PWP in a memory controller 130. The logical write pointer LWP may denote a write pointer WP identified from the standpoint of a host device 102. Accordingly, the logical write pointer LWP is updated when the user data U_DAT received from the host device 102 is written. The physical write pointer PWP may be a value indicating the position of last data that is actually written to the memory device 150 and includes the internal data IN_DAT. Accordingly, the physical write pointer PWP is updated when data received from the host device 102 is written, and is also updated even when the internal data IN_DAT is written by the memory controller 130. Referring to FIG. 7, the user data U_DAT received from the host device 102 is written to physical blocks #1 to #3. The internal data IN_DAT is not written, and thus positions indicated by the logical write pointer LWP and the physical write pointer PWP are the same.

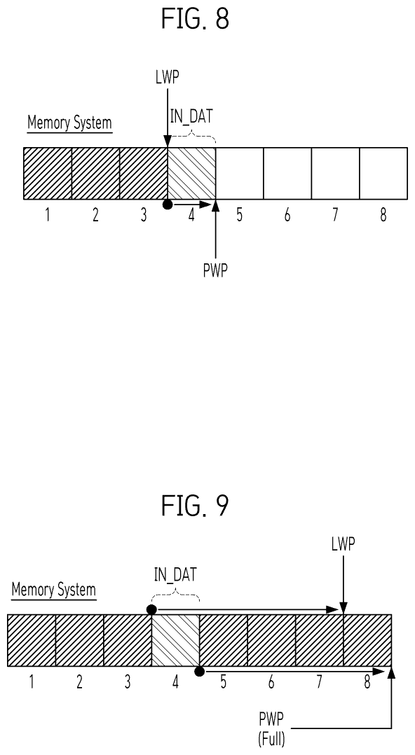

FIG. 8 is a diagram illustrating a process of updating a logical write pointer and a physical write pointer when internal data is written according to a method illustrated in FIG. 6. Referring to FIG. 8, a write pointer WP update method is performed when the internal data IN_DAT is written in the zone states illustrated in FIG. 6. In FIG. 7, the user data U_DAT was written to physical blocks #1 to #3 and the internal data IN_DAT was not written. Therefore, positions indicated by the physical write pointer PWP and the logical write pointer LWP are the same. Next, however, the internal data IN_DAT may be written to physical block #4. As illustrated in FIG. 8, although a write operation of the internal data IN_DAT is performed by the memory controller 130, the position indicated by the logical write pointer LWP is not updated from the standpoint of the host device 102. When the write operation of the internal data IN_DAT is performed by the memory controller 130, the memory controller 130 updates the position indicated by the physical write pointer PWP as the corresponding write operation is performed. Accordingly, the positions indicated by the physical write pointer PWP and the logical write pointer LWP may be different from each other.

Referring to FIG. 8, data written to physical block #4 is internal data IN_DAT, and thus step S770 of FIG. 6 is performed based on the determination at step S730. That is, when the internal data IN_DAT is written, the position indicated by the logical write pointer LWP is not updated, and the position indicated by the physical write pointer PWP is updated.

FIG. 9 is a diagram illustrating a process of updating a logical write pointer and a physical write pointer when the user data is written in accordance with the method illustrated in FIG. 6.

FIG. 9 shows how a write pointer WP is updated in a zone state shown in FIG. 8 when writing four new user data U_DAT is newly requested from a host device 102.

In the zone state illustrated in FIG. 8, data (U_DAT, IN_DAT) is written through physical block #4. Four user data U_DAT may be newly write requested by the host device 102. Since the internal data IN_DAT is written to the corresponding zone, the positions indicated by a physical write pointer PWP and a logical write pointer LWP are different from each other.

As illustrated in FIG. 9, the position indicated by the logical write pointer LWP is updated by four physical blocks #4 to #7 from the standpoint of the host 102. The updated logical write pointer LWP indicates logical block #7.

The memory controller 130 may perform a write operation of the four user data U_DAT to four physical blocks #5 to #8. The memory controller 130 may update the physical write pointer PWP. The updated physical write pointer PWP indicates physical block #8. That is, when the user data U_DAT is written, the logical write pointer LWP is updated by the host device 102 and the memory controller 130. On the contrary, when the internal data IN_DAT is written, the physical write pointer PWP is only updated by the memory controller 130.

Referring to FIG. 9, the physical write pointer PWP has already reached the size of the zone (i.e., eight physical blocks), which means that the corresponding zone is full. In contrast, referring to FIG. 9, from the standpoint of the host device 102, the logical write pointer LWP indicates logical block #7. Thus, the host device 102 may determine that the user data U_DAT corresponding to one logical block #8 can be further write requested. In order to avoid this problem, when a write request with the user data U_DAT is received from the host device 102, the memory controller 130 determines the logical write pointer LWP of the host device 102 by using the logical block address of the user data U_DAT or a size of the user data U_DAT. The logical write pointer LWP may be received from the host device 102 with the write request.

The memory controller 130 may determine whether positions indicated by the logical write pointer LWP and the physical write pointer PWP corresponding to the received write request match each other.

When it is determined that the addresses indicated by the logical write pointer LWP and the physical write pointer PWP match each other, it means that the internal data IN_DAT is not written to the corresponding zone. Therefore, the memory controller 130 may determine, based on the position indicated by the logical write pointer LWP, whether an available area for writing the user data U_DAT received from the host device 102 remains in the corresponding zone. When the available area for writing the user data U_DAT remains in the corresponding zone, the memory controller 130 may temporarily store the received user data U_DAT in the write buffer 231, and may transfer a normal response message corresponding to the write request to the host device 102. When the available area for writing the user data U_DAT received from the host device 102 is not in the corresponding zone, the memory controller 130 may transfer a failure message to the host device 102. In this case, the state of the zone may be changed to a full zone (FULL), as illustrated in FIG. 3, and another zone for writing the corresponding data may be selected.

When it is determined that the logical write pointer LWP and the physical write pointer PWP do not match each other, it means that the internal data IN_DAT is written to the corresponding zone. Therefore, the memory controller 130 may determine, based on the position indicated by the physical write pointer PWP, whether an available area for writing the user data U_DAT received from the host device 102 remains in the corresponding zone. When the available area for writing the user data U_DAT received from the host device 102 remains in the corresponding zone, the memory controller 130 may notify the host device 102 that the available area is present in the corresponding zone. In this case, the host device 102 may temporarily store the received the user data U_DAT in the write buffer 231, and may transfer a normal response message corresponding to the write request to the host device 102. When the available area for writing the user data U_DAT received from the host device 102 does not remain in the corresponding zone, the memory controller 130 may notify the host device 102 that an available area is not present in the corresponding zone. In this case, the host device 102 may transfer a fail message to the host device 102, and the state of the zone may be changed to a full zone (FULL), as illustrated in FIG. 3. Another zone for writing the corresponding data may be selected.

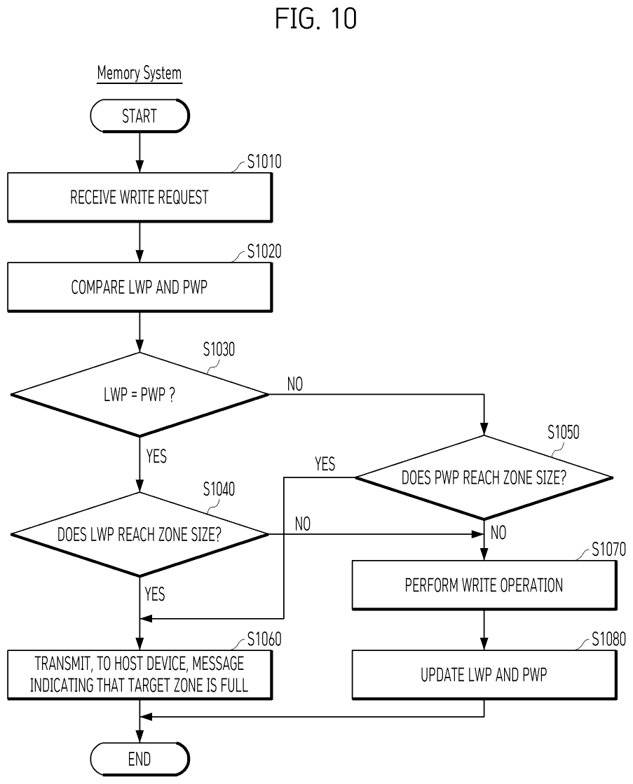

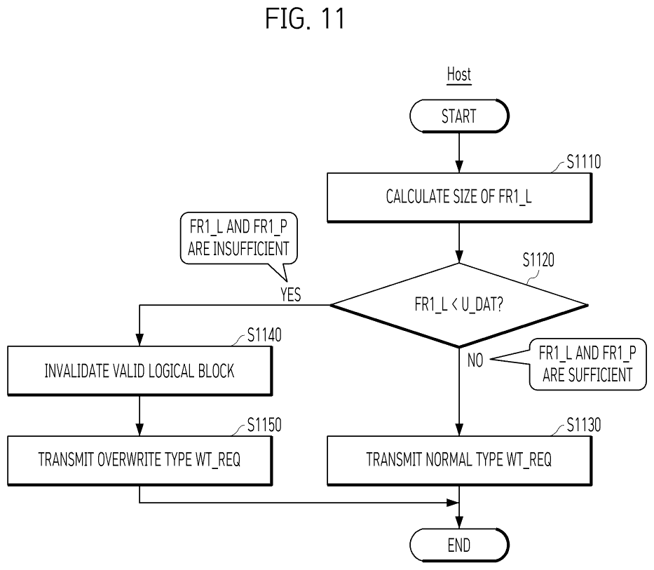

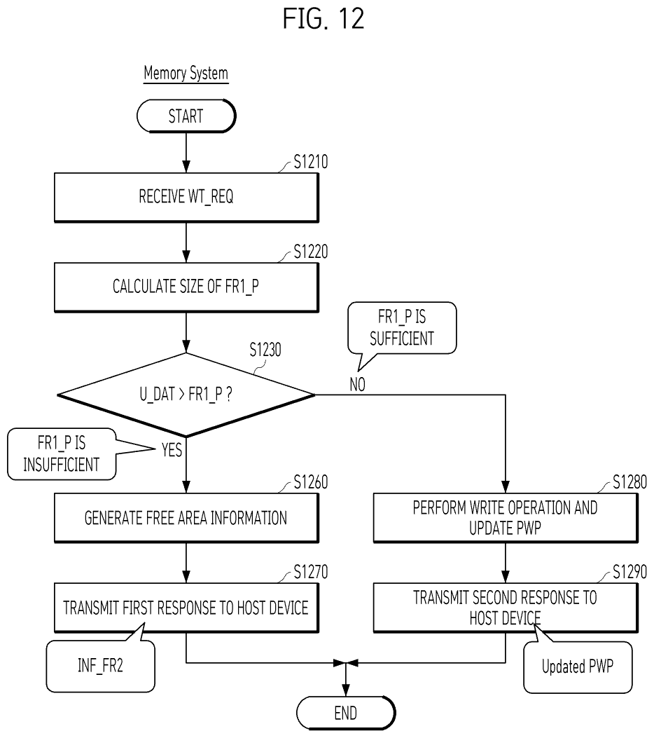

FIG. 10 is a flowchart illustrating an operation of a memory controller in accordance with an embodiment of the present disclosure. More specifically, FIG. 10 is a flowchart illustrating an operation of a memory controller 130 when a write request is received from a host device 102.

Referring to FIG. 10, the memory controller 130 receives a write request from the host device 102 at step S1010. The memory controller 130 compares a logical write pointer LWP and a physical write pointer PWP of a zone corresponding to the write request with each other at step S1020. Step S1020 may be performed by the memory controller 130.

At step S1030, a determination is made as to whether the positions indicated by the logical write pointer LWP and the physical write pointer PWP are identical to each other. When the positions indicated by the logical write pointer LWP and the physical write pointer PWP are identical to each other (i.e., “Yes” at step S1030), it means that the internal data IN_DAT is not stored in the corresponding zone. Therefore, whether the logical write pointer LWP has reached the size of the zone is determined at step S1040. When the logical write pointer LWP has reached the size of the zone (i.e., “Yes” at step S1040), a message indicating that the corresponding zone (i.e., selected zone) is full is transferred to the host device 102 at step S1060. When the logical write pointer LWP has not reached the size of the zone (i.e., “No” at step S1040), a data write operation corresponding to the write request received from the host device 102 is performed at step S1070. At step S1070, a write command and program data corresponding to the received write request and received data, respectively, may be transferred to the memory device 150. The memory device 150 may perform a write operation based on the received write command and the received program data. The logical and physical write pointer PWPs of the zone corresponding to the write operation are updated at step S1080. Step S1080 may correspond to step S750 of FIG. 6.

When the positions indicated by the logical write pointer LWP and the physical write pointer PWP are not identical to each other (i.e., “No” at step S1030), it means that the internal data IN_DAT is stored in the corresponding zone. Therefore, whether the physical write pointer PWP has reached the size of the zone is determined at step S1050. When it is determined that the physical write pointer PWP has reached the size of the zone (i.e., “Yes” at step S1050), a message indicating that the corresponding zone (selected zone) is full is transferred to the host device 102 at step S1060. When the physical write pointer PWP has not reached the size of the zone (i.e., “No” at step S1050), a data write operation corresponding to the write request received from the host device 102 is performed at step S1070. At step S1070, a write command and program data corresponding to the received write request and received data, respectively, may be transferred to the memory device 150. The memory device 150 may perform a write operation based on the received write command and the received program data. The logical and physical write pointer PWPs of the zone corresponding to the write operation are updated at step S1080. Step S1080 may correspond to step S750 of FIG. 6.

Hereinafter, with reference to FIGS. 11, 12, 13, and 14A to 14E, a method in which the host device 102 and a memory system 110 synchronize different logical write pointers LWP and physical write pointers PWP in connection with internal data IN_DAT is described.

In the following description, data DAT may include user data U_DAT and internal data IN_DAT. A zone corresponding to a write request WT_REQ described above is referred to as a “target zone”. In embodiments of the present disclosure, an available area included in the target zone is referred to as a “free area FR1”. The free area FR1 refers to an area where no data is allocated or stored. The free area FR1 determined by the host device 102 is referred to as a “logical free area FR1_L,” and the free area FR1 determined by the memory controller 130 is referred to as a “physical free area FR1_P”.

The sum of “the size of the data allocated or stored in the target zone” and “the size of the free area FR1” may correspond to the “size of the target zone”. For a write operation of the user data U_DAT, an available area that needs to be additionally secured in the target zone is referred to as an “additional free area FR2”.

FIG. 11 is a flowchart illustrating an operation in which a host device generates a write request in accordance with an embodiment of the present disclosure. In particular, FIG. 11 describes a method for efficiently using a target zone without opening a new zone when a “logical free area FR1_L” of the target zone is insufficient.

In accordance with an embodiment of the present disclosure, a host device 102 to which a zoned name space is applied may transmit a write request WT_REQ to a memory system 110 in order to request a write operation WT_OP of the user data U_DAT. When a normal response message indicating that the write operation WT_OP corresponding to the write request WT_REQ has been completed is received from the memory system 110, the host device 102 may update an index of a physical write pointer PWP included in the normal response message into an index of a logical write pointer LWP. The host device 102 may also map a physical write pointer PWP received from the memory system 110 to a logical write pointer LWP.

The logical write pointer LWP may indicate the range of a valid logical area to which the user data U_DAT is allocated, among a plurality of logical areas included in the target zone. The logical write pointer LWP may be used to distinguish a plurality of logical areas from a valid logical area and a logical free area FR1_L to which no the user data U_DAT is allocated. The logical area may correspond to a logical block.

The physical write pointer PWP may indicate the range of a valid physical area where data (U_DAT, IN_DAT) is stored among a plurality of physical areas included in the target zone. The physical write pointer PWP may distinguish a plurality of physical areas from a valid physical area and a physical free area FR1_P in which no data is stored. The physical area may correspond to a physical block.

In order to generate the write request WT_REQ, the host device 102 may calculate the size of the logical free area FR1_L of the target zone (S1110). The size of the logical free area FR1_L is managed by the host device 102 and may be calculated based on the logical write pointer LWP stored in a host device memory Host Memory 106 in FIG. 4.

The logical free area FR1_L is included in the target zone and refers to a logical free area FR1_L where no data is allocated. The host device 102 may calculate the size of the logical free area FR1_L by subtracting the logical write pointer LWP from the size of the target zone.

The host device 102 may compare the size of the user data U_DAT and the size of the logical free area FR1_L (S1120).

When the size of the user data U_DAT is not greater than the size of the logical free area FR1_L (i.e., “NO” in S1120), the host device 102 may determine that the sizes of the logical free area FR1_L and the physical free area FR1_P are sufficient to store the user data U_DAT. Accordingly, the host device 102 may transmit a normal type write request WT_REQ to the memory system 110 (S1130). In an embodiment of the present disclosure, the normal type write request WT_REQ may be a write request for the user data DAT allocated to a free logical block. That is, the normal type write request WT_REQ may be a write request in which no the user data U_DAT is reallocated to an invalid logical block.

When the size of the user data U_DAT is greater than the size of the logical free area FR1_L (i.e., “YES” in S1120), the host device 102 may determine that the sizes of the logical free area FR1_L and the physical free area FR1_P are insufficient to store the user data U_DAT. Accordingly, the host device 102 may invalidate at least some of the valid logical blocks, included in the target zone, to which data has already been allocated (S1140). Invalidating the logical block may refer to deallocating data allocated to the logical block. The host device 102 may reallocate the user data U_DAT to the invalidated logical block and the logical free area FR1_L. At this time, if a free logical block exists in the target zone, then the host device 102 may allocate the user data U_DAT to the free logical block as well.

Subsequently, the host device 102 may transmit an overwrite type write request WT_REQ to the memory system 110 (S1150). In an embodiment of the present disclosure, the overwrite type write request WT_REQ may be a write request for the user data U_DAT allocated to an invalid logical block and the free logical block.

In this way, when the “logical free area FR1_L” of the target zone is insufficient, the host device 102 may efficiently use the target zone ZONE_1 by using an overwrite type write request WT_REQ.

FIG. 12 is a flowchart illustrating an operation in which a memory system in accordance with another embodiment of the present disclosure determines whether to perform a write operation. In particular, in FIG. 12, a memory system 110 may notify a host device 102 that the logical write pointer LWP and the physical write pointer PWP are different from each other through a response corresponding to the write request WT_REQ. In FIG. 12, descriptions of steps overlapping FIG. 10 is omitted, but the present disclosure may also include an embodiment in which FIGS. 10 and 12 are combined.

The memory system 110 to which the zoned name space is applied may include a memory device 150 including a plurality of zones. The memory system 110 may include a memory controller 130 that controls the memory device 150 so that a write operation WT_OP is performed on a plurality of physical blocks included in each of the plurality of zones.

Referring to FIG. 12, the memory system 110 may receive the write request WT_REQ for the target zone from the host device 102 (S1210). The write request WT_REQ may include user data U_DAT and a logical block address LBA assigned to the user data U_DAT.

When the write request WT_REQ is received, the memory system 110 may determine whether the write operation WT_OP can be performed in the target zone. Based on the size of the physical free area FR1_P of the target zone and the size of the user data U_DAT, the memory system 110 may determine whether a write operation WT_OP can be performed.

To this end, the memory system 110 may calculate the size of the physical free area FR1_P included in the target zone (S1220). The size of the physical free area FR1_P may be managed by the memory system 110, and may be calculated based on the physical write pointer PWP stored in a memory unit 230 of FIG. 4. The physical free area FR1_P is included in the target zone and refers to the size of a physical area where no data is stored. The physical free area FR1_P may correspond to a physical block in which no data is stored.

When the type of the write request WT_REQ is normal, the memory system 110 may calculate the size of the physical free area FR1_P by subtracting the physical write pointer PWP from the size of the target zone. When the type of write request WT_REQ is overwrite, the memory system 110 may calculate the size of the physical free area FR1_P by subtracting the size of a physical block requested for overwriting from the physical write pointer PWP.

When the size of the user data U_DAT requested to be written from the host device 102 is greater than the size of the physical free area FR1_P (i.e., “YES” in S1230), the memory system 110 may determine that the write operation WT_OP is not possible because the size of the physical free area FR1_P is insufficient to store the user data U_DAT.

Accordingly, the memory system 110 may generate free area information INF_FR2 on an additional free area FR2 that needs to be additionally secured in the target zone in order to perform the write operation WT_OP (S1260).

The free area information INF_FR2 may include information necessary for the host device 102 to calculate the size of the additional free area FR2. The free area information INF_FR2 may include ‘the size of the physical free area FR1_P’, ‘the physical write pointer PWP of the target zone’, and ‘the sum of the physical write pointer PWP and the length LENGTH of the user data U_DAT requested to be written’. Since the host device 102 has information on the size of the target zone and the size of the user data U_DAT, the host device 102 may calculate the size of the additional free area FR2 that needs to be additionally secured by using the free area information INF_FR2 received from the memory system 110. The free area information INF_FR2 may also include the size of the additional free area FR2 calculated by the memory system 110.

The memory system 110 may put the free area information INF_FR2 into a first response R1 to the write request WT_REQ and transmit the first response R1 to the host device 102 (S1270). The first response R1 may further include a message indicating a failure FAIL in performing the write operation WT_OP.

The fact that the size of the user data U_DAT requested to be written from the host device 102 is greater than the size of the physical free area FR1_P may indicate that the locations of the logical write pointer LWP and the physical write pointer PWP are different from each other. Accordingly, the memory system 110 in accordance with an embodiment of the present disclosure may notify the host device 102 through the operation of S1270 that the locations of the logical write pointer LWP and the physical write pointer PWP are not the same. Accordingly, the host device 102 may synchronize the logical write pointer LWP and the physical write pointer PWP for a target zone ZONE_1 by using an overwrite type write request WT_REQ.

When the size of the user data U_DAT requested to be written from the host device 102 is not greater than the size of the physical free area FR1_P (NO in S1230), the memory system 110 may determine that the write operation WT_OP is possible because the locations of the logical write pointer LWP and the physical write pointer PWP are the same and the size of the physical free area FR1_P is sufficient to store the user data U_DAT.

Accordingly, the memory system 110 may sequentially perform the write operation WT_OP on the plurality of physical blocks included in the target zone (S1280). Subsequently, the memory system 110 may update the address PBA of the last physical block subject to the write operation WT_OP into the physical write pointer PWP of the target zone (S1280). Accordingly, the logical write pointer LWP and the physical write pointer PWP may be synchronized.

The memory system 110 may put the updated physical write pointer PWP into a second response R2 to the write request WT_REQ and transmit the second response R2 to the host device 102 (S1290). The second response R2 may further include a message indicating success SUCCESS of the write operation WT_OP.

In this way, the memory system 110 in accordance with an embodiment of the present disclosure may determine whether the logical write pointer LWP and the physical write pointer PWP are at the same position and whether a write operation WT_OP is possible according to the result of comparing the sizes of the physical free area FR1_P and the user data U_DAT. Depending on the comparison result, the memory system 110 may transmit the free area information INF_FR2 on the additional free area FR2, which needs to be additionally secured in the target zone, to the host device 102 as the first response R1 to the write request WT_REQ.

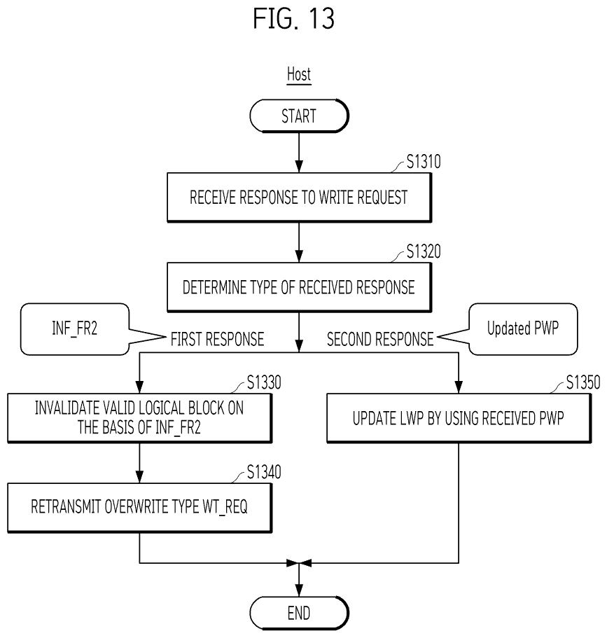

FIG. 13 is a flowchart illustrating a method in which a host device performs a subsequent operation in response to a write request received from a memory system in accordance with an embodiment of the present disclosure.

When a response to the write request WT_REQ is received from a memory system 110 (S1310), a host device 102 may determine the type of the received response (S1320).

When the type of the received response is a first response R1 including a free area information INF_FR2, the host device 102 may determine that an area of the target zone of the memory system 110 is insufficient to store the user data U_DAT. Accordingly, based on the free area information INF_FR2 received from the memory system 110, the host device 102 may invalidate at least some of the valid logical blocks included in the target zone (S1330).

The host device 102 may reallocate the user data U_DAT to an invalid logical block and retransmit an overwrite type write request WT_REQ to the memory system 110 (S1340).

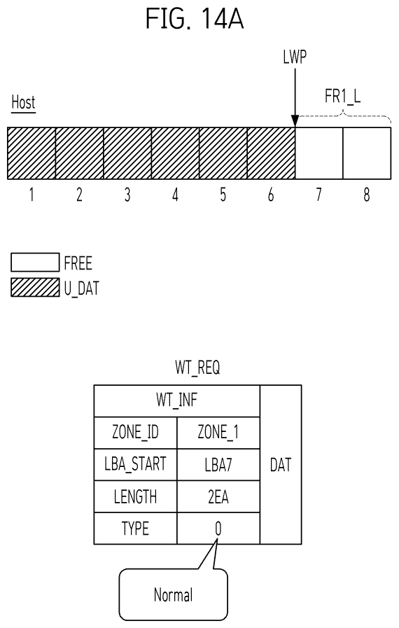

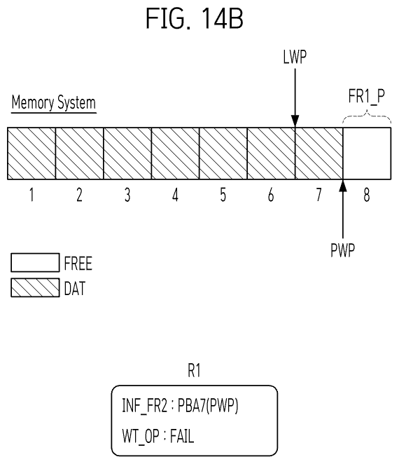

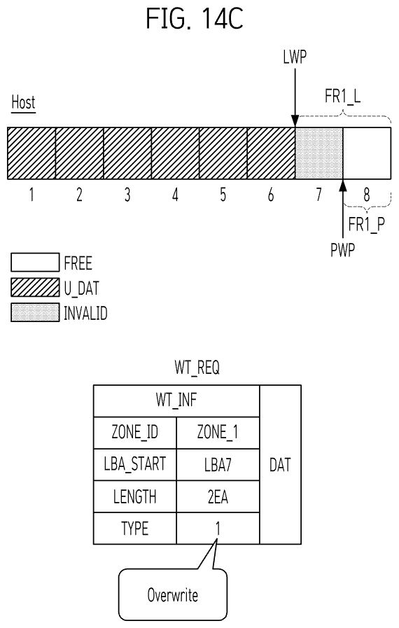

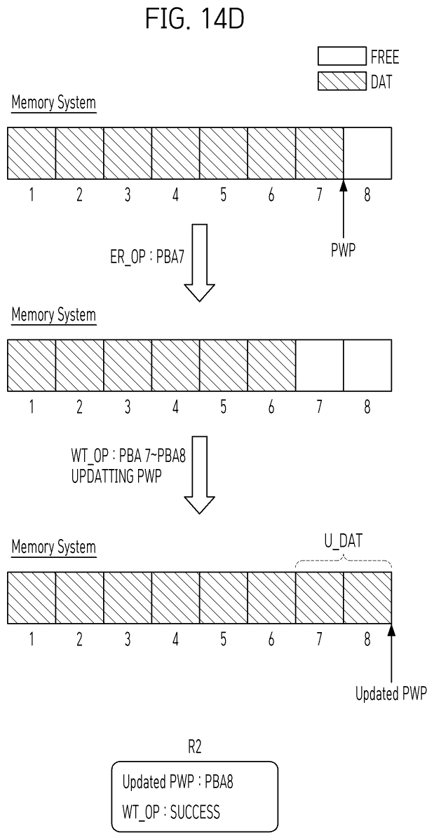

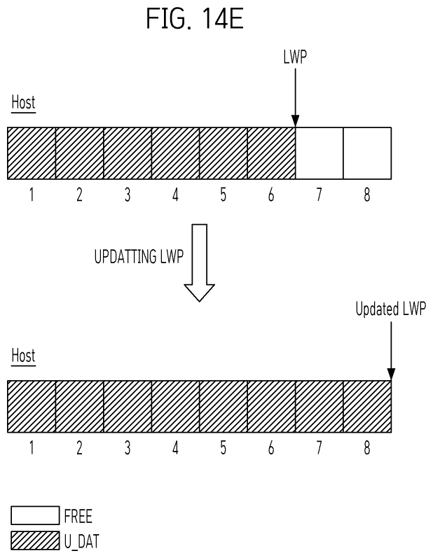

When the overwrite type write request WT_REQ is received from the host device 102, the memory system 110 may perform erase and write operations on a corresponding physical block, thereby synchronizing the logical write pointer LWP and the physical write pointer PWP. This is be described in detail with reference to FIGS. 14A to 14E.

When the type of the received response is a second response R2 including an updated physical write pointer PWP, the host device 102 may determine that the memory system 110 has successfully completed the write operation. Accordingly, the host device 102 may update the logical write pointer LWP by using the physical write pointer PWP received from the memory system 110 (S1350). Accordingly, the logical write pointer LWP and the physical write pointer PWP may be synchronized.

FIGS. 14A to 14E are diagrams illustrating a process of performing a write operation described in FIGS. 11 to 13. Hereinafter, with reference to FIGS. 14A to 14E, a write operation in accordance with an embodiment of the present disclosure described in FIGS. 11 to 13 is described in detail.

FIG. 14A is a flowchart illustrating a method in which a host device 102 in accordance with an embodiment of the present disclosure generates a write request WT_REQ based on the size of a logical free area included in a target zone.

FIG. 14A exemplarily illustrates an operation of the host device 102 described in S1110, S1120, and S1130 of FIG. 11.

The host device 102 in accordance with an embodiment of the present disclosure may generate a write request WT_REQ for the user data U_DAT with a size corresponding to two logical blocks. To this end, the host device 102 may calculate the size of the logical free area FR1_L included in the target zone ZONE_1.

As illustrated in FIG. 14A, the size of the target zone ZONE_1 corresponds to eight logical blocks LBA 1 to LBA 8, and the logical write pointer LWP may be “LBA6”. Accordingly, the host device 102 may determine that data has already been allocated to six logical blocks among the eight logical blocks included in the target zone ZONE_1, and two logical blocks LBA 7 and LBA 8 are in the logical free area FR1_L.

Since the size of the user data U_DAT is the same as the size of the logical free area FR1_L, the host device 102 may determine that the size of the logical free area FR1_L is sufficient to store the user data U_DAT. Accordingly, the host device 102 may allocate the data DAT to the free logical blocks LBA 7 and LBA 8 and transmit a normal type write request WT_REQ to the memory system 110.

As illustrated in FIG. 14A, the write request WT_REQ may include request information WT_INF and the user data U_DAT. The request information WT_INF may include identification information ZONE_ID for the target zone ZONE_1, logical block address LBA_START and LENGTH assigned to the user data U_DAT, and the type TYPE of the write request WT_REQ. The logical block address may include a start logical block address LBA_START and a data length LENGTH, which is the number of logical blocks consecutive to the start logical block address LBA_START. For example, when the start logical block address LBA_START is ‘LBA7’ and the data length LENGTH is ‘2’, this may refer to the user data U_DAT allocated to two logical blocks corresponding to ‘LBA7 to LBA8’.

In an embodiment, the host device 102 may set a bit indicating the type of the write request WT_REQ to a reset state (for example, a first value) or to a set state (for example, a second value), thereby expressing the type of the write request WT_REQ. In an embodiment of the present disclosure, when the type TYPE of the write request WT_REQ is “0”, it may indicate a normal type, and when the type TYPE of the write request WT_REQ is “1”, it may indicate an overwrite type; however, the embodiment is not particularly limited thereto.

FIG. 14B exemplarily illustrates an operation of the memory system 110 described in S1230, S1260, and S1270 of FIG. 12.

When a normal type write request WT_REQ for the user data U_DAT corresponding to two logical blocks LBA 7 and LBA 8 is received from the host device 102, the memory system 110 may calculate the size of the physical free area FR1_P of the target zone ZONE_1 based on the physical write pointer PWP.

As illustrated in FIG. 14B, the size of the target zone ZONE_1 corresponds to eight physical blocks PBA 1 to PBA 8, and the physical write pointer PWP may be “PBA7”. Accordingly, the memory system 110 may determine that data has already been stored in seven physical blocks among the eight physical blocks included in the target zone ZONE_1 and one physical block PBA 8 is the physical free area FR1_P.

Since the size of the user data U_DAT requested to be written from the host device 102 is greater than the size of the physical free area FR1_P, the memory system 110 may determine that the write operation WT_OP is not possible. Subsequently, the memory system 110 may determine that the physical write pointer PWP managed by the memory system 110 and the logical write pointer LWP managed by the host device 102 are different from each other.

Accordingly, the memory system 110 may generate free area information INF_FR2 related to the additional free area FR2 required in the target zone ZONE_1. Subsequently, the memory system 110 may put the free area information INF_FR2 into the first response R1 to the write request WT_REQ and transmit the first response R1 to the host device 102. The first response R1 may further include a message indicating a failure FAIL in performing the write operation WT_OP.

As illustrated in FIG. 14B, the free area information INF_FR2 included in the first response R1 may include “PBA7” indicating the physical write pointer PWP of the target zone ZONE_1. Although not illustrated in FIG. 14B, the free area information INF_FR2 may include “9EA” indicating the sum of the sizes of the physical write pointer PWP and the data DAT. The free area information INF_FR2 may further include “1EA” indicating the size of the additional free area FR2 calculated by the memory system 110.

FIG. 14C exemplarily illustrates an operation of the host device 102 described in S1320, S1330, and S1340 of FIG. 13.

When the response received from the memory system 110 is the first response R1, the host device 102 may determine that no write operation has been performed because a physical area included in the target zone ZONE_1 is insufficient to store the user data U_DAT. Subsequently, the host device 102 may determine that the logical write pointer LWP and the physical write pointer PWP are different from each other based on the free area information INF_FR2 included in the first response R1. Subsequently, the host device 102 may determine that the size of the additional free area FR2 that needs to be additionally secured in the target zone ZONE_1 of the memory system 110 is 1EA.

At this time, the host device 102 may open a new zone (for example, ZONE_2) to which no data is assigned, and allocate user data U_DAT to the new zone ZONE_2. However, in this case, since LBA8 indicating a free logical block included in the target zone ZONE_1 is not used for data allocation, a problem may occur that reduces efficiency of the target zone ZONE_1.

In order to solve the above problem, the host device 102 in accordance with an embodiment of the present disclosure may invalidate at least one (for example, LBA 7) of the valid logical blocks included in the target zone ZONE_1, reallocate the user data U_DAT to the invalidated LBA 7 and “LBA 8” indicating a free logical block, and retransmit an overwrite type write request WT_REQ to the memory system 110.

FIG. 14D exemplarily illustrates an operation of the memory system 110 described in S1230, S1280, and S1290 of FIG. 12.

When the overwrite type write request WT_REQ is received from the host device 102, the memory system 110 may perform an erase operation ER_OP on “PBA 7” corresponding to “7”.

Subsequently, the memory system 110 may perform a write operation WT_OP of the user data U_DAT requested to be written on “PBA 7” subjected to the erase operation ER_OP and “PBA 8” indicating a free physical block. Subsequently, the memory system 110 may update the physical write pointer PWP from the existing “PBA7” to “PBA 8”.

The memory system 110 may put “PBA 8” indicating an updated physical write pointer PWP into the second response R2 to the write request WT_REQ and transmit the second response R2 to the host device 102. The second response R2 may further include a message indicating SUCCESS of the write operation WT_OP.

FIG. 14E exemplarily illustrates an operation of the host device 102 described in S1320 and S1350 of FIG. 13.

When the response received from the memory system 110 is the second response R2, the host device 102 may determine that the write operation on the write request WT_REQ has been successfully completed. Accordingly, the host device 102 may update the updated physical write pointer PWP included in the second response R2 into the logical write pointer LWP. That is, “LBA6” indicating the existing logical write pointer LWP may be updated into “LBA8” indicating a logical block address corresponding to the updated physical write pointer PWP “PBA8”.

The above description is merely intended to illustratively describe the technical spirit of the present disclosure, and various changes and modifications can be made by those skilled in the art to which the present disclosure pertains without departing from the essential features of the present disclosure. Therefore, the embodiments disclosed in the present disclosure are not intended to limit the technical spirit of the present disclosure, but are intended to describe the present disclosure. The scope of the technical spirit of the present disclosure is not limited by these embodiments. The scope of the present disclosure should be interpreted by the accompanying claims and all technical spirits falling within the equivalent scope thereto should be interpreted as being included in the scope of the present disclosure.

What is claimed is:

1. A memory system employing a zoned name space, the memory system comprising:
a memory device including a plurality of physical areas corresponding to each of a plurality of zones; and
a memory controller configured to control the memory device to perform a write operation on the physical areas,
wherein, when a write request is received from a host device, the memory controller
determines a size of a physical free area, in which no data is stored, that is included in a target zone of the write request,
compares the size of the physical free area and a size of user data requested to be written, and
determines whether to transmit free area information on an additional free area required in the target zone for a write operation on the user data, to the host device, according to result of the comparison.

2. The memory system of claim 1, wherein the memory controller transmits a first response, including the free area information, corresponding to the write request to the host device when the size of the user data is greater than the size of the physical free area.

3. The memory system of claim 2, wherein the first response further includes a failure message indicating that the write operation for the user data is not performed.

4. The memory system of claim 1, wherein the free area information includes a physical write pointer indicating a size of a physical area where data is stored in the target zone.

5. The memory system of claim 4, wherein the free area information includes a sum of the physical write pointer and the size of the user data.

6. The memory system of claim 1, wherein the free area information includes the size of the physical free area.

7. The memory system of claim 1, wherein the free area information includes a size of the additional free area.

8. The memory system of claim 4, wherein the memory controller calculates the size of the physical free area by subtracting the physical write pointer from a size of the target zone when the write request is a normal type.

9. The memory system of claim 4, wherein the memory controller calculates the size of the physical free area by subtracting a size of a physical block requested for overwriting from the physical write pointer when the write request is an overwrite type.

10. The memory system of claim 1, wherein the memory controller sequentially performs the write operation for the user data on the physical free area, and updates a physical write pointer of the target zone when the size of the user data is not greater than the size of the physical free area.

11. The memory system of claim 10, wherein the physical write pointer includes an address of a last physical area subjected to the write operation among the physical areas in the target zone.

12. The memory system of claim 10, wherein the memory controller transmits a second response corresponding to the write request, including the updated physical write pointer, to the host device.

13. The memory system of claim 12, wherein the second response further includes a success message indicating that the write operation for the user data is successfully performed.

14. A data processing system comprising:
a host device, including a plurality of logical areas corresponding to each of a plurality of zones, configured to allocate a user data to a logical free area of a target zone and to generate a write request for the allocated user data; and
a memory system configured to transmit a response, to the host device, indicating whether a write operation corresponding to the write request has failed,
wherein the host device determines whether to invalidate at least some of valid logical areas included in the target zone, according to a comparison result of a size of the logical free area and a size of the user data, when the host device allocates the user data.

15. The data processing system of claim 14, wherein the host device invalidates at least some of the valid logical areas of the target zone and allocates the user data to the invalidated logical areas and the logical free area when the size of the user data is greater than the size of the logical free area.

16. The data processing system of claim 14, wherein the host device allocates the user data to the logical free area when the size of the user data is not greater than the size of the logical free area.

17. The data processing system of claim 14, wherein the host device invalidates at least some of the valid logical areas of the target zone based on free area information, and re-allocates the user data to the invalidated logical areas and the logical free area, and re-transmits the write request to the memory system when the response received from the memory system includes the free area information,
wherein the free area information indicates an additional free area required in the target zone for the write operation for the user data.

18. The data processing system of claim 17, wherein the response further includes a failure message indicating that the write operation is not performed.

19. The data processing system of claim 14, wherein, when the response received from the memory system includes a physical write pointer reflecting the write operation, the host device updates a logical write pointer of the target zone based on the physical write pointer.

20. The data processing system of claim 14, wherein the host device calculates the size of the logical free area based on a logical write pointer indicating a logical area to which data is allocated and a size of the target zone.

21. The data processing system of claim 17, wherein the free area information includes a physical write pointer indicating a size of a physical area where data is stored in the target zone.

22. The data processing system of claim 21, wherein the free area information includes a sum of the physical write pointer and the size of the user data.

23. The data processing system of claim 17, wherein the free area information includes a size of a physical free area.

24. The data processing system of claim 17, wherein the free area information includes a size of the additional free area.
